(19) United States
(12) Patent Application Publication
(10) Pub. No.: US 2025/0392076 A1
(43) Pub. Date: Dec. 25, 2025

(54) PLUG AND SOCKET ASSEMBLY

(71) Applicant: ZHIYONG HU, Shenzhen (CN)

(72) Inventor: ZHIYONG HU, Shenzhen (CN)

(21) Appl. No.: 18/918,856

(22) Filed: Oct. 17, 2024

(30) Foreign Application Priority Data
Jun. 19, 2024 (CN) 202421403663.3

(51) Int. Cl. H01R 13/633; H01R 13/70; H01R 13/717

(52) U.S. Cl. CPC H01R 13/6335; H01R 13/70; H01R 13/7175

(57) ABSTRACT

Disclosed is a plug and socket assembly, including a plug and a socket, where the plug is provided with a first grip structure, and the first grip structure is a through-hole that penetrates through the plug, or a groove with a certain depth. One or two grooves may be arranged, and when there are two grooves, they are arranged on two opposite faces of the socket, and are directly opposite to each other. The plug is electrically connected to a cable, and the cable is in T-shaped or line-shaped connection with the plug.

### CROSS-REFERENCE TO RELATED APPLICATIONS

This application claims priority to Chinese Patent Application No. 202421403663.3, filed on Jun. 19, 2024, which is hereby incorporated by reference in its entirety.

### TECHNICAL FIELD

The present disclosure relates to the technical field of electrical connectors, and particularly relates to a plug and socket assembly.

### BACKGROUND

In the prior art, one end of a plug and socket assembly is a plug, and the other end thereof is a socket. The plug is connected to the socket through a cable. The plug is configured to connect to a mains socket, and the socket is used to connect electrical devices. Any of existing plug and socket assemblies has a defect that the plug or the socket has no structure through which a user can conveniently grip, which brings inconvenience to the user in use. Further, any of existing plug and socket assemblies has no luminous structure, and cannot be used in low light situations conveniently, thus needing further improvements.

### SUMMARY

An objective of the present disclosure is to provide a plug and socket assembly, so as to solve the problem that the plug or the socket of any of existing plug and socket assemblies has no structure through which a user can conveniently grip, which brings inconvenience to the user in use.

The present disclosure is implemented as follows: a plug and socket assembly, including a plug and a socket, where the plug is provided with a first grip structure, and the first grip structure is a through-hole that penetrates through the plug, or a groove with a certain depth; one or two grooves may be arranged, and when there are two grooves, they are arranged on two opposite faces of the socket, and are directly opposite to each other; and the plug is electrically connected to a cable, and the cable is in T-shaped or line-shaped connection with the plug.

Further, an end of the cable away from the plug is electrically connected to the socket, the socket is provided with a second grip structure, and the second grip structure is a through-hole that penetrates through the socket, or a groove with a certain depth. One or two grooves may be arranged, and when there are two grooves, they are arranged on two opposite faces of the socket, and are directly opposite to each other.

Further, a decorative element is embedded in the first grip structure and/or the second grip structure, and the decorative element is made of a luminescent or translucent material.

Further, the plug further includes a circuit board, a LED lamp bead, and an inductive switch arranged therein, where both the LED lamp bead and the inductive switch are electrically connected to the circuit board.

Further, the LED lamp bead is arranged behind the decorative element, and when the LED lamp bead lights up, the light therefrom is transmitted through the decorative element.

Further, an upper surface of the LED lamp bead is in contact with an opposite surface of the decorative element, to make the emitted light softer according to a principle of light refraction.

Further, the inductive switch is configured to be a human sensor switch, where the human sensor switch is any one of an infrared sensor switch, a radar sensor, and a microwave sensor.

Further, the inductive switch is arranged at the top or on any side of the housing of the plug.

Further, the plug is provided with two or three metal pins, and the metal pins are fixedly and electrically connected to the cable in one-to-one correspondence. When there are two metal pins, they are a neutral wire pin and a live wire pin respectively, or an anode pin and a cathode pin respectively. When there are three metal pins, they are the neutral wire pin, the live wire pin and a ground wire pin respectively, or the anode pin, the cathode pin and the ground wire pin respectively.

Further, the socket is provided with two or three jacks, a metal connector is arranged in each of the jacks, and the metal connectors are fixedly and electrically connected to the cable in one-to-one correspondence.

Compared with the prior art, the present disclosure has the beneficial effects as follows:

1. The plug of the present disclosure is provided with the first grip structure, and the socket is provided with the second grip structure, so that a user can grip and use the plug and the socket more conveniently.

2. The plug of the present disclosure further includes a circuit board, a LED lamp bead, and an inductive switch, where both the LED lamp bead and the inductive switch are electrically connected to the circuit board. When the body of the user approaches the inductive switch, the circuit board controls the LED lamp bead to light up to achieve a night light function of the plug. When the LED lamp bead lights up, the user can conveniently use the plug at night.

3. A decorative element is embedded in the first grip structure and/or the second grip structure of the present disclosure, and the decorative element made of a luminescent material can glow in low light situations, so that the user can conveniently and quickly insert and remove the plug or the socket.

### BRIEF DESCRIPTION OF DRAWINGS

FIG. 1 is a schematic diagram of a three-dimensional structure of the present disclosure.

FIG. 2 is a schematic diagram of a three-dimensional structure of a plug of the present disclosure.

FIG. 3 is a schematic diagram of an internal structure of a plug of the present disclosure.

FIG. 4 is a schematic diagram of a three-dimensional structure of a socket of the present disclosure.

In the figures: 1, plug; 2, socket; 3, cable; 4, first grip structure; 5, second grip structure; 6, decorative element; 7, circuit board; 8, LED lamp bead; 9, inductive switch; 10, metal pin; and 11, jack.

### DESCRIPTION OF EMBODIMENTS

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinary skill in the art, the specific meanings of the terms described above in the present disclosure may be interpreted according to specific circumstances.

The present disclosure will be further described below with reference to the accompanying drawings and the specific embodiments.

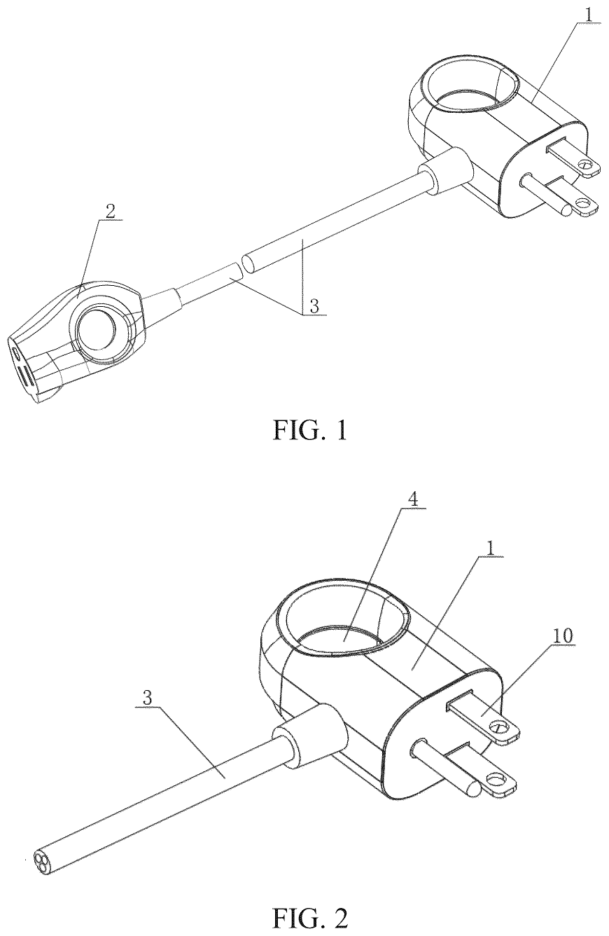

A plug and socket assembly, as shown in FIGS. 1, 2, and 4, includes a plug 1, a socket 2, and a cable 3. The plug 1 and the socket 2 are electrically connected through the cable 3, the cable 3 is in T-shaped or line-shaped connection with the plug 1, and the cable 3 is also in T-shaped or line-shaped connection with the socket 2. The plug 1 is provided with a first grip structure 4, and the first grip structure 4 is a through-hole that penetrates through the plug 1, or a groove with a certain depth. One or two grooves may be arranged, and when there are two grooves, they are arranged on two opposite faces of the socket 2, and are directly opposite to each other. The socket 2 is provided with a second grip structure 5, and the second grip structure 5 is a through-hole that penetrates through the socket 2, or a groove with a certain depth. One or two grooves may be arranged, and when there are two grooves, they are arranged on two opposite faces of the socket 2, and are directly opposite to each other.

It can be seen from the above that the plug 1 of the present disclosure is provided with the first grip structure 4, and the socket 2 is provided with the second grip structure 5, so that a user can grip and use the plug 1 and the socket 2 more conveniently.

As shown in FIG. 2, the plug 1 is provided with two or three metal pins 10, and the metal pins 10 are fixedly and electrically connected to the cable 3 in one-to-one correspondence. When there are two metal pins 10, they are a neutral wire pin and a live wire pin respectively, or an anode pin and a cathode pin respectively. When there are three metal pins 10, they are the neutral wire pin, the live wire pin and a ground wire pin respectively, or the anode pin, the cathode pin and the ground wire pin respectively.

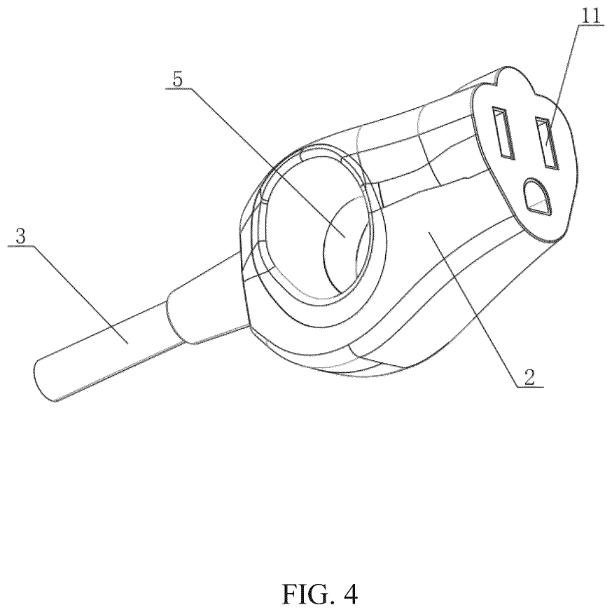

As shown in FIG. 4, the socket 2 is provided with two or three jacks 11, a metal connector is arranged in each of the jacks 11, the metal connectors are fixedly and electrically connected to the cable 3 in one-to-one correspondence, and the metal connectors are electrically connected to the metal pins 10 through the cable 3.

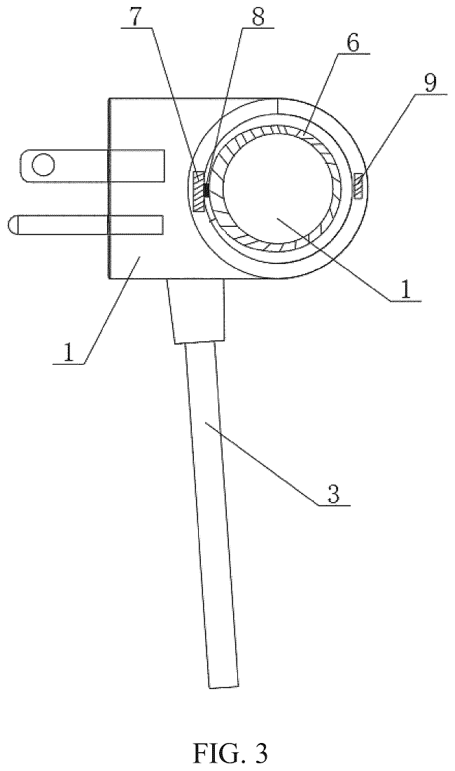

As shown in FIG. 3, a decorative element 6 is embedded in the first grip structure 4 and/or the second grip structure 5, and the decorative element 6 is made of a luminescent or translucent material. The decorative element 6 made of a luminescent material can glow in low light situations, so that the user can conveniently and quickly insert and remove the plug 1 or the socket 2.

As shown in FIG. 3, the plug 1 further includes a circuit board 7, a LED lamp bead 8, an inductive switch 9, and a battery arranged inside a plug housing, where both the LED lamp bead 8 and the inductive switch 9 are electrically connected to the circuit board 7, and the battery supplies power to the circuit board 7, the LED lamp bead 8, and the inductive switch 9. The inductive switch 9 is arranged at the top or on any side of the housing of the plug 1, and the inductive switch 9 is configured to be a human sensor switch, where the human sensor switch is any one of an infrared sensor switch, a radar sensor, and a microwave sensor. The LED lamp bead 8 is arranged behind the decorative element 6, and when the LED lamp bead 8 lights up, the light therefrom is transmitted through the decorative element 6. When the body of the user approaches the inductive switch 9, the circuit board 7 controls the LED lamp bead 8 to light up to achieve a night light function of the plug 1. When the LED lamp bead 8 lights up, the user can conveniently use the plug 1 at night. An upper surface of the LED lamp bead 8 is in contact with an opposite surface of the decorative element 6, to make the emitted light softer and non-glaring according to a principle of light refraction. The circuit board 7 is provided with a delayed light-off program, which automatically turns off the LED lamp bead 8 10-20 sec later after the body of the user leaves a sensing range of the inductive switch 9.

The above descriptions are only preferred embodiments of the present disclosure and are not intended to limit the present disclosure, and various changes and modifications may be made to the present disclosure by those skilled in the art. Any modifications, equivalent substitutions, improvements, etc. within the spirit and principles of the present disclosure are intended to fall within the scope of protection of the present disclosure.

What is claimed is:

1. A plug and socket assembly, comprising a plug and a socket, wherein the plug is provided with a first grip structure, and the first grip structure is a through-hole that penetrates through the plug, or a groove with a certain depth; one or two grooves may be arranged, and when there are two grooves, they are arranged on two opposite faces of the socket, and are directly opposite to each other; and the plug is electrically connected to a cable, and the cable is in T-shaped or line-shaped connection with the plug.

2. The plug and socket assembly according to claim 1, wherein an end of the cable away from the plug is electrically connected to the socket, the socket is provided with a second grip structure, and the second grip structure is a through-hole that penetrates through the socket, or a groove with a certain depth; one or two grooves may be arranged, and when there are two grooves, they are arranged on two opposite faces of the socket, and are directly opposite to each other.

3. The plug and socket assembly according to claim 2, wherein a decorative element is embedded in the first grip structure and/or the second grip structure, and the decorative element is made of a luminescent or translucent material.

4. The plug and socket assembly according to claim 3, wherein the plug further comprises a circuit board, a LED lamp bead, and an inductive switch arranged therein, wherein both the LED lamp bead and the inductive switch are electrically connected to the circuit board.

5. The plug and socket assembly according to claim 4, wherein the LED lamp bead is arranged behind the decorative element, and when the LED lamp bead lights up, the light therefrom is transmitted through the decorative element.

6. The plug and socket assembly according to claim 5, wherein an upper surface of the LED lamp bead is in contact with an opposite surface of the decorative element, to make the emitted light softer according to a principle of light refraction.

7. The plug and socket assembly according to claim 4, wherein the inductive switch is configured to be a human sensor switch, wherein the human sensor switch is any one of an infrared sensor switch, a radar sensor, and a microwave sensor.

8. The plug and socket assembly according to claim 7, wherein the inductive switch is arranged at the top or on any side of the housing of the plug.

9. The plug and socket assembly according to claim 1, wherein the plug is provided with two or three metal pins, and the metal pins are fixedly and electrically connected to the cable in one-to-one correspondence; when there are two metal pins, they are a neutral wire pin and a live wire pin respectively, or an anode pin and a cathode pin respectively; and when there are three metal pins, they are the neutral wire pin, the live wire pin and a ground wire pin respectively, or the anode pin, the cathode pin and the ground wire pin respectively.

10. The plug and socket assembly according to claim 2, wherein the socket is provided with two or three jacks, a metal connector is arranged in each of the jacks, and the metal connectors are fixedly and electrically connected to the cable in one-to-one correspondence.
